(19) United States
(12) Patent Application Publication
(10) Pub. No.: US 2025/0371369 A1
(43) Pub. Date: Dec. 4, 2025

(54) FEDERATED QUERIES FOR MULTIPLE DATA SILOS ASSOCIATED WITH A PRODUCT

(71) Applicant: Siemens Healthineers AG, Forchheim (DE)

(72) Inventors: Behrang ASHTARI, Baiersdorf (DE); Vishnudev Krishnadas VISHNUDEV KRISHNADAS, Erlangen (DE); Frederic SAID, Moehrendorf (DE)

(73) Assignee: Siemens Healthineers AG, Forchheim (DE)

(21) Appl. No.: 19/226,945

(22) Filed: Jun. 3, 2025

(30) Foreign Application Priority Data
Jun. 4, 2024 (DE) 10 2024 205 140.3

(51) Int. Cl. G06N 3/096; G06F 16/2458; G06F 40/30; G06F 40/40

(52) U.S. Cl. CPC G06N 3/096; G06F 16/2471; G06F 40/30; G06F 40/40

(57) ABSTRACT

Various examples of the disclosure generally relate to federated queries for accessing data from multiple data silos that are associated with a product, such as a medical imaging device. Various examples of the disclosure more specifically relate to a language model for generating such federated queries. Various examples of the disclosure also more specifically relate to fine-tuning such language model.

### CROSS-REFERENCE TO RELATED APPLICATION(S)

The present application claims priority under 35 U.S.C. § 119 to German Patent Application No. 10 2024 205 140.3, filed Jun. 4, 2024, the entire contents of which are incorporated herein by reference.

### FIELD

Various examples of the disclosure generally relate to finetuning a pre-trained language model. Various examples specifically relate to finetuning a pre-trained language model using knowledge associated with a domain-specific ontology, and/or knowledge associated with one or more vocabulary. The language model can then be used to generate a federated query associated with a hardware and/or software product from a prompt.

### BACKGROUND

Data analysis of enterprise-wide data supports informed decision-making and a more holistic view of hidden opportunities or threats. However, different departments of an enterprise, e.g., finance department, administration department, human resources department, marketing department, and other departments, need access to different information to accomplish their tasks. Those different departments tend to store their data in separate locations known as data or information silos. Siloed data creates barriers to information sharing and collaboration across departments.

There are several techniques available for retrieving data from various data silos within an organization, e.g., an enterprise. These techniques vary depending on factors such as the type of data silos, the structure of the data, and the integration requirements.

For example, SPARQL (a recursive acronym for SPARQL Protocol and RDF Query Language) is a Resource Description Framework (RDF) query language—that is, a semantic query language for databases—able to retrieve and manipulate data stored in Resource Description Framework (RDF) format. It was made a standard by the RDF Data Access Working Group (DAWG) of the World Wide Web Consortium (W3C) and is recognized as one of the key technologies of the semantic web.

SPARQL is a query language used to express queries across diverse data sources, whether the data is stored natively as RDF or viewed as RDF via middleware. To retrieve desired data from diverse data sources or data silos using SPARQL, a SPARQL query needs to be created. In recent years, the conversion of natural language questions to SPARQL queries gained increasing popularity.

Various techniques are known to generate SPARQL queries. For example, non-patent literature-Rony, Md Rashad Al Hasan, et al. “Sgpt: A generative approach for SPARQL query generation from natural language questions.” IEEE Access 10 (2022): 70712-70723. [1]-discloses a generative approach for SPARQL query generation from natural language questions. A new approach was proposed, dubbed SGPT, that combines the benefits of end-to-end and modular systems and leverages recent advances in large-scale language models.
Non-patent literature—Luz F F, Finger M. Semantic parsing natural language into SPARQL: improving target language representation with neural attention. arXiv preprint arXiv: 1803.04329.2018 Mar. 12. [2]-discloses semantic parsing natural Language into SPARQL. Semantic parsing is the process of mapping a natural language sentence into a formal representation of its meaning. A neural network approach was utilized to transform a natural language sentence into a query to an ontology database in the SPARQL language.
Non-patent literature—Wang R, Zhang Z, Rossetto L, Ruosch F, Bernstein A. Nlqxform: A language model-based question to sparql transformer. arXiv preprint arXiv: 2311.07588.2023 Nov. 8. [3]-discloses a language model-based question to SPARQL transformer.
Non-patent literature—Panchbhai A, Soru T, Marx E. Exploring Sequence-to-Sequence Models for SPARQL Pattern Composition. arXiv preprint arXiv: 2010.10900.2020 Oct. 21. [4]-discloses the use of sequence-to-sequence models as a viable and promising option to transform long utterances into complex SPARQL queries.
Non-patent literature—Nikolov, Andriy, et al. “Ephedra: Efficiently combining RDF data and services using SPARQL federation.” Knowledge Engineering and Semantic Web: 8th International Conference, KESW 2017, Szczecin, Poland, Nov. 8-10, 2017, Proceedings 8. Springer International Publishing, 2017. [5]-discloses a SPARQL federation engine aimed at processing hybrid queries called Ephedra. Ephedra provides a flexible declarative mechanism for including hybrid services into a SPARQL federation and implements a number of static and runtime query optimization techniques for improving the hybrid SPARQL queries performance.
Non-patent literature—Heling L, Acosta M. Federated SPARQL query processing over heterogeneous linked data fragments. InProceedings of the ACM Web Conference 2022 2022 Apr. 25 (pp. 1047-1057). [6]-discloses an interface-aware framework for SPARQL query processing over federations with heterogeneous Linked Data Fragment interfaces.

The techniques disclosed in non-patent literature demonstrate the feasibility of invoking hybrid federated services from within a SPARQL query, i.e., enhancing SPARQL Query with hybrid federated services.
Non-patent literature—Sima, Ana Claudia, et al. “Enabling semantic queries across federated bioinformatics databases.” Database 2019 (2019): baz106. [7]-discloses an ontology-based federated approach for data integration. This approach utilizes natural language templates (e.g., user interface form) for federated query construction aiming to relieve users from the need to manually compose SPARQL queries in the biomedical domain. However, in this solution, users are still required to manually complete the template, comprehend the content within the template, and understand the semantic metadata.

Additionally, classical natural language processing techniques have also been used to address the building of SPARQL queries from natural language.

For example, Non-patent literature—Sander M, Waltinger U, Roshchin M, Runkler T. Ontology-based translation of natural language queries to SPARQL. In 2014 AAAI fall symposium series 2014 Sep. 24. [8] —discloses an implemented approach to transform natural language sentences into SPARQL, using background knowledge from ontologies and lexicons.
US patent application 2010/0185643 A1 discloses techniques for automated generation of queries for querying ontologies.

### SUMMARY

As will be appreciated from the above, various techniques are known to generate queries. However, all such techniques are limited in that they cannot flexibly generate queries to access a variety of data silos. Typically, the techniques disclosed above only work well when generating a query for a given data silo. Abstraction to other data silos is not possible or only possible to a limited degree.

Therefore, the inventors have identified that a need exists for advanced techniques for accessing multiple data silos and retrieving desired data from the multiple data silos. Specifically, the inventors have identified that a need exists for advanced techniques of automatically generating a precise query from natural language to retrieve desired data from multiple data silos associated with a product.

At least this need is met by the features of the independent claims. The features of the dependent claims define embodiments.

A computer-implemented method for fine-tuning a pre-trained language model for generating a federated query associated with a product from a prompt is provided. The method comprises obtaining first semantic metadata associated with an ontology representing concepts of the product and second semantic metadata associated with a vocabulary describing the concepts of the product. The method further comprises fine-tuning the pre-trained language model based on the first semantic metadata associated with the ontology and further based on the second semantic metadata associated with the vocabulary.

A further computer-implemented method is provided. The method comprises obtaining a prompt describing desired data associated with a product. The method further comprises generating, based on the prompt, a federated query associated with the desired data using a pre-trained language model fine-tuned by the computer-implemented method described above.

A computing device comprising a processor and a memory is provided. Upon loading and executing program code from the memory, the processor is configured to perform a method for fine-tuning a pre-trained language model for generating a federated query associated with a product from a prompt is provided. The method comprises obtaining first semantic metadata associated with an ontology representing concepts of the product and second semantic metadata associated with a vocabulary describing the concepts of the product. The method further comprises fine-tuning the pre-trained language model based on the first semantic metadata associated with the ontology and further based on the second semantic metadata associated with the vocabulary.

A computer program product or a computer program or a non-transitory computer-readable storage medium including program code is provided. The program code can be executed by at least one processor. Executing the program code causes the at least one processor to perform a method for fine-tuning a pre-trained language model for generating a federated query associated with a product from a prompt is provided. The method comprises obtaining first semantic metadata associated with an ontology representing concepts of the product and second semantic metadata associated with a vocabulary describing the concepts of the product. The method further comprises fine-tuning the pre-trained language model based on the first semantic metadata associated with the ontology and further based on the second semantic metadata associated with the vocabulary.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 is a flowchart of a method according to various examples.

FIG. 2 schematically illustrates a processing pipeline according to various examples.

FIG. 3 schematically illustrates a workflow according to various examples.

FIG. 4 schematically illustrates a processing device according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques for accessing multiple data silos and retrieving desired data using a federated query generated from a prompt are disclosed. In each of multiple data silos, data is stored in separate, isolated repositories within an organization, and these repositories are managed and accessed independently of one another. Data silos may arise due to a variety of reasons, such as the use of different technology systems that are not interoperable, organizational structures that limit data access to specific groups, or historical growth of an organization.

For example, the multiple data silos may be associated with different entities within a large organization. For example, the multiple data silos may be associated with different entities involved in the production process of a product. For example, a first entity may participate in R&D activities to plan and develop a product; a second entity may be responsible for sourcing parts to build the product; a third entity may be responsible for validating the source parts of a product; the fourth entity may be responsible for manufacturing the product; and a fifth entity may be responsible for quality control of the manufactured product. This is just an example. Other examples are possible. For example, different data silos may be associated with different manufacturing machines on an assembly line. For example, different data silos may be associated with different departments in a hospital that work together to provide a diagnosis for a patient. In a further example, multiple data silos are associated with different components of a product such as an MRI scanner, a computed tomography scanner, etc. Typically, different components of a product are developed by different persons within an organization and/or are manufactured by different production lines. Accordingly, there is a tendency that these different entities maintain isolated data silos that need to be accessed with a federated query.

A product may be a hardware product or a software product. Example products include hardware-software products. A technical product may be subject to the techniques disclosed herein. A medical imaging device is an example product. For example products include, e.g., transport or mobility products such as vehicles, trains, airplanes, etc. Medical devices, laboratory equipment, testing machines a further examples. Energy conversion devices such as wind turbines, gas turbines, generators, power plants, nuclear power plants, coal power plants, etc. further examples. Green-technology products such as solar cells, fuel cells, batteries are further examples.

Such products may include multiple components. All such products may include multi-step manufacturing processes. All such products may be developed by multiple companies and/or multiple entities within a company.

In general, as used throughout this disclosure, a federated query is a query that spans multiple data silos, sources, or repositories distributed across different locations or systems. Instead of querying a single, centralized database, a federated query allows a user to retrieve data from multiple sources/data silos in a unified manner. Federated queries enable organizations to access and integrate data associated with a product from heterogeneous sources in a unified manner, providing a comprehensive view of the data landscape without the need for centralized data storage.

For example, according to W3C SPARQL standards, SPARQL 1.1 defines syntax and semantics for executing queries distributed over different SPARQL endpoints, i.e., federation (or federated) query . . . . Here, the federated query includes a “protocol and resource framework query language” query. Non-patent literature—Rakhmawati N A, Umbrich J, Karnstedt M, Hasnain A, Hausenblas M. Querying over Federated SPARQL Endpoints—A State of the Art Survey. arXiv preprint arXiv: 1306.1723. 2013 Jun. 7.—discloses summarisation of techniques for querying over federated SPARQL endpoints

According to this disclosure, a prompt is natural language text describing the task that an Artificial intelligence (AI) should perform. For example, a prompt for a text-to-text language model can be a query, a command, or a longer statement including context, instructions, and conversation history.

According to this disclosure, the federated query may be generated using a pre-trained language model. The pre-trained language model including large language models and small language models.

In general, large language models are sophisticated AI models that are capable of understanding and generating human-like text across various languages and topics. These models are built using deep learning techniques, e.g., transformer architectures, and are trained on massive datasets consisting of billions or even trillions of words. Large language models have millions or even billions of parameters, which are the internal variables that the model learns during training. These parameters enable the model to capture complex relationships between words and generate coherent and contextually relevant text. Examples of large language models may include GPT (Generative Pre-trained Transformer) models developed by OpenAI, BERT (Bidirectional Encoder Representations from Transformers) developed by Google, T5 (Text-to-Text Transfer Transformer) developed by Google, and others. On the other hand, small language models are less complex versions of large language models, typically with fewer parameters and trained on smaller datasets. For example, small language models may have fewer than a million parameters, often in the range of thousands to hundreds of thousands. Small language models may be trained on smaller datasets which are sampled from subsets of larger datasets or curated to focus on specific domains or topics. Examples of small language models may include Phi-2 as disclosed in non-patent literature-Javaheripi, Mojan, et al. “Phi-2: The surprising power of small language models.” Microsoft Research Blog (2023). [9], and Orca 2 as disclosed in non-patent literature-Mitra A, Del Corro L, Mahajan S, Codas A, Simoes C, Agarwal S, Chen X, Razdaibiedina A, Jones E, Aggarwal K, Palangi H. Orca 2: Teaching small language models how to reason. arXiv preprint arXiv: 2311.11045. 2023 Nov. 18.

As a general rule, language models typically employ deep learning architecture that includes of multiple layers, each configuredt o process and transform input data through a series of mathematical operations. These language models typically employ transformer architectures. A transformer architecture employs a so-called attention mechanisms to weigh the importance of different words in a sequence; this enables to process context. Layers are used that perform linear transformations followed by non-linear activations. Each layer is associated with a set of weights, which are adjustable parameters that the model optimizes during training through backpropagation and gradient descent methods in machine learning. The learning process involves adjusting the weights of the network to minimize a loss function, which quantifies the difference between the model's predictions and the actual data.

To facilitate the generation of a federated query, e.g., an SPARQL federated query, for a specific use case or domain, the pre-trained language model may need to be fine-tuned based on use-case-specific or domain-specific information or knowledge.

Hereinafter, techniques for fine-tuning a pre-trained language model for generating a federated query associated with a product are disclosed. The federated query is generated from a prompt, e.g., a prompt describing desired data/information associated with the product. The pre-trained language model is fine-tuned based on first semantic metadata associated with an ontology representing concepts of the product and further based on second semantic metadata associated with a vocabulary describing the concepts of the product.

In general, the product may comprise any industrial product or any consumer product. For example, the product may comprise an electric appliance, a car, or a bus. According to various examples, the product may comprise a projection radiographic scanner, a magnetic resonance imaging scanner, a computed tomography scanner, a positron emission tomography scanner, a single-photon emission computed tomography scanner, or an ultrasound scanner.

According to this disclosure, semantic metadata may refer to descriptive information about data that is encoded using semantic technologies and standards. Semantic metadata may include structured knowledge representations that enable automated reasoning and inference. For example, semantic metadata may be associated with Semantic Web technologies such as RDF, OWL (Web Ontology Language), or SPARQL, which may provide the foundations for encoding, publishing, and querying semantic metadata on the web.

In general, an ontology is a formal, explicit specification of a conceptualization. It is a way of representing knowledge about a particular domain by defining the types of entities that exist within it and the relationships between them. Ontologies may be used to structure and organize knowledge in a systematic and machine-readable way. An ontology representing concepts of a product may provide a specification of the concepts, entities, and relationships within a domain associated with the product. Such an ontology may use vocabulary and/or syntax to describe knowledge associated with the product. In general, ontologies define various types of entities within a domain. An ontology includes, for each domain (or specifically for each product), classes, instances, attributes, and relationships. Classes represent categories or types of things, instances are individual members of those categories, attributes describe properties or characteristics of entities, and relationships specify connections between entities.

An example ontology for a product “MRI scanner” may include multiple classes such as “bias field magnet system”, “gradient coils”, “RF coils”, and “control and imaging software”. For example, attributes of the “bias field magnet system” class may include properties such as “field strength”, “coolant type”, and “magnet architecture”. “Gradient coil” class attributes may include properties such as “maximum gradient strength”, “slew rate”, or “design”. The relationships between these classes are generally complex, but to give a few examples, the “control and imaging software” must interact with each of the other classes to implement an imaging protocol. Furthermore, the “gradient coils” are used to encode a magnetic field gradient according to the imaging protocol, which is tailored to the bias magnetic field applied by the “bias field magnet system”, which is captured by the respective relationship between the “gradient coils” class and the “bias field magnet system” class. For instance, a given MRI scanner type may be compatible with multiple RF coil systems, thereby specifying different instances of the class “RF coils”.

Generally, an ontology can be represented as a graph data structure. For instance, in a graph data structure representing the ontology of an “MRI scanner” provided as an example above, each class (such as “bias field magnet system,” “gradient coils,” “RF coils,” and “control and imaging software”) can be visualized as a node. Attributes of these classes, like “field strength” for the “bias field magnet system” or “maximum gradient strength” for the “gradient coils,” can be represented as properties attached to the respective nodes. The relationships between these classes, such as the interaction of the “control and imaging software” with other parts, or the dependency of “gradient coils” on the “bias field magnet system,” are depicted as edges linking the relevant nodes.

According to this disclosure, a vocabulary may comprise a structured collection of terms (words or phrases) used to describe concepts, entities, or relationships within a specific domain or subject area, e.g., the domain associated with the product. It may comprise a set of terms that provides a shared understanding of the terminology used in a particular field, allowing for consistent and unambiguous communication among users and systems.

To give another concrete example, the vocabulary for an MRI scanner may include entries such as “Bias Field Magnet System”, “Field Strength”, “Coolant Type”, and “Magnet Architecture”. Each entry may include some descriptive text, for instance: “Field Strength refers to the intensity of the magnetic field produced by the magnet, typically measured in Tesla”; and “Coolant Type is the type of cooling agent used, often liquid helium, to maintain the magnet system's temperature”; and “Magnet Architecture describes the structural design of the magnet system, such as superconducting or permanent magnet designs.”. In the “Gradient Coils” category, entries may include “Maximum Gradient Strength”, “Slew Rate”, and “Design”. Here, the follow explanation may be given: “Maximum Gradient Strength measures the highest strength of the gradient field achievable by the coils, noted in milli tesla per meter”; “Slew Rate is the speed at which gradient coils can alter the magnetic field, measured in tesla per meter per second”; “Design specifies the physical configuration of the coils, either cylindrical or planar”. For the “RF Coils” class, terms like “Coil Type”, “Number of Channels”, and “Material” may be used. Some example explanations would be: “Coil Type classifies the coil based on its application, such as head coil or body coil”; “Number of Channels indicates the number of independent channels in the coil, affecting image quality and acquisition speed”; and “Material refers to the type of conductive material used, typically copper or silver, influencing signal sensitivity and performance.”.

As will be appreciated, the entries of the ontology may match the entries of the vocabulary. Thus, the same concepts that are represented by the ontology are also described by the vocabulary.

According to various examples, fine-tuning the pre-trained language model based on the first semantic metadata associated with the ontology and further based on the second semantic metadata associated with the vocabulary may be performed using standard training procedures for neural networks such as semi-supervised learning, unsupervised learning, or supervised learning. Generally, such techniques are known to the skilled person. The particular training technique employed is not germane for the disclosure and pre-existing techniques may be readily employed.

More generally, fine-tuning a language model builds on the pre-training. Initially, during pre-training, the language model learns general language patterns from general text data. i.e., text data that is not limited to a specific domain or product. This is achieved by adjusting the model's internal parameters, or weights, through a process called backpropagation. Backpropagation iteratively minimizes a function known as the loss, which measures the discrepancy between the model's predictions and the actual data. This training helps the model develop a broad understanding of language, which is not specific to any particular domain. In the subsequent phase of fine-tuning, the pre-trained model is further refined on a smaller, domain-specific dataset; in the present case the first and second semantic metadata. The finetuning allows the language model to adapt its previously learned weights to perform well on tasks specific to that product/domain. By continuing to use backpropagation to minimize the loss on this new dataset, the model becomes specialized, enhancing its ability to generate or interpret texts that are more aligned with the domain-specific needs.

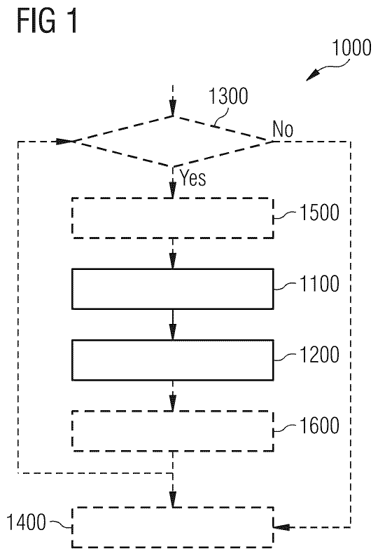

FIG. 1 illustrates aspects with respect to a method 1000 for fine-tuning a pre-trained language model for generating a federated query associated with a product, in which dashed blocks indicate optional processing steps. The federated query is generated from a prompt, e.g., a prompt describing desired data/information associated with the product from multiple data silos associated with different components and/or manufacturing steps and/or organizational departments associated with the product. The pre-trained language model is fine-tuned based on first semantic metadata associated with an ontology representing concepts of the product and further based on second semantic metadata associated with a vocabulary describing the concepts of the product. Details of the method 1000 are described below.

Block 1100: obtaining first semantic metadata associated with an ontology representing concepts of the product and second semantic metadata associated with a vocabulary describing the concepts of the product.

Block 1200: fine-tuning the pre-trained language model based on the first semantic metadata associated with the ontology and further based on the second semantic metadata associated with the vocabulary.

Optionally or additionally, at block 1100, the method 1000 may further comprise obtaining third semantic metadata associated with at least one configured federated service. Each of the at least one configured federated service is mapped to a data silo storing data associated with the product. Accordingly, at block 1200, said fine-tuning of the pre-trained language model may be further based on the third semantic metadata associated with the at least one configured federated service.

In general, federated service may be related to multiple service endpoints, e.g., physical devices that connect to a network system such as mobile devices, desktop computers, virtual machines, embedded devices, and servers. An endpoint may comprise devices positioned in a specific location or a specific Uniform Resource Locator (URL) where a service can be accessed or queried for data.

For example, the multiple service endpoints may comprise devices of a federated system or a distributed database management system. Within a federated system, a single SPARQL query can access services or data that are distributed among several endpoints or data sources. The SPARQL federated query may have the capability of using multiple SERVICE keywords to query and merge data from different endpoints.

According to various examples, if the data stored at an endpoint is not in RDF, such an endpoint can convert the data into RDF by use of a service, e.g., a middleware, which may be a general purpose service that acts as an intermediary between systems facilitating common grounds for communication. Such federated service may define services associated with the product. I.e., information retrieval, building of a manual, servicing and/or maintenance service. Thus, specific use cases associated with the product can be captured. The query can thus be tailored to these use cases.

For example, for MRI scanners, a federated SPARQL query may use the “SERVICE” keyword as defined by W3C standards to call different services, e.g., an MRI open platform communications (OPC) unified architecture (UA) server service, a product lifecycle management (PLM) system service, and/or a hospital data service.

The MRI OPC-UA server service may interface with the MRI system's OPC-UA server to retrieve real-time temperature data from the coil system and a frequency of use of an MRI scanner per hour. The MRI OPC-UA server service may expose endpoints for querying temperature sensor readings and other relevant data.

The PLM system service may interact with the PLM system to retrieve technical data like design data, such as cabling data and simulation data, related to the MRI coil system. The PLM system service may provide endpoints for accessing this information in a structured format.

The hospital data service may gather temperature data from sensors installed throughout the hospital environment. The hospital data service may provide endpoints for querying temperature readings from various locations within a specific hospital.

A federated query associated with an MRI scanner may comprise variables to be retrieved from one or more services, e.g., an MRI open platform communications (OPC) unified architecture (UA) server service, a product lifecycle management (PLM) system service, and/or a hospital data service.

Results of the federated query associated with the MRI scanner may include a real-time temperature of the MRI coil system, the MRI scanner's design data, and/or ambient temperature of a hospital environment. All of the results may be integrated into a single cohesive result set.

At block 1100, the method 1000 may further include obtaining one or more problems and one more corresponding ground-truth federated queries. Thus, example ground-truth queries associated with prompts can be obtained. Thereby, input-output pairs of training data for subsequently fine-tuning the language model can be formed.

According to various examples, said fine-tuning of the pre-trained model may be based on one or more vector embeddings of the semantic metadata. For example, the one or more vector embeddings may be generated based on the first semantic metadata associated with the ontology and further based on the second semantic metadata associated with the vocabulary. As another example, the one or more vector embeddings may be generated based on the first semantic metadata associated with the ontology, further based on the second semantic metadata associated with the vocabulary, and additionally based on the third semantic metadata associated with the at least one configured federated service.

A vector embedding is determined from input data-here, e.g., a graph representation of the ontology-through a series of predefined computational steps designed. Each embedding is a fixed-size, dense numerical vector. Generation of the vector embedding may include preprocessing to normalize and format the input data suitably. This may include tokenization and normalization for the text in the vocabulary. The processed data is then fed into a predefined model, e.g., a neural network, which has been trained to capture the salient features of the data. This model, depending on its architecture, uses layers of neurons to apply nonlinear transformations to the input, adjusting internal weights. The output layer of the model generates the vector embedding, which represents the input data in a high-dimensional space. This vector embedding is a representation of the input data, e.g., the ontology or the vocabulary, in a compact vector space facilitates efficient storage, processing, and analysis.

Optionally or additionally, the method 1000 may further comprise, at block 1300, determining at least one change associated with any one of the ontology, the vocabulary, or a configured federated service. Said fine-tuning of the pre-trained language model is triggered based on said determining of the at least one change.

In particular, the ontology, the vocabulary and/or further information may be monitored, i.e., repetitively checked for changes. Upon detecting such change, a retraining may be triggered. Retraining may be generally executed in batches such that it may be determined whether a certain number of changes, e.g., a number of changes exceeding a threshold count of changes, has occurred before triggering a retraining. By implementing such adaptive retraining that is automatically triggered, it can be ensured that the pre-trained language model is maintained up to date and adjusts to changes in the different data silos. The federated query can thereby be up to date. Accurate information retrieval becomes possible. At the same time, the operation of the user's associated with the different data silos is not compromised, i.e., their working style can remain unaffected.

Above, techniques have been disclosed in which the fine-tuning of a language model is triggered based on determining that, e.g., an ontology has changed. Alternatively or additionally, such fine-tuning of the language model can also be triggered based on a predefined timing schedule. For instance, the fine-tuning may be triggered periodically or at certain trigger dates/times. This may facilitate keeping the language model up to date even in case large data sets are being operated on and, accordingly, difficulties in monitoring the changes. The required computational resources may be reduced.

According to various examples, before fine-tuning the pre-trained language model based on the first semantic metadata associated with the ontology and further based on the second semantic metadata associated with the vocabulary, the method 1000 may further comprise, at block 1500, fine-tuning or modifying the architecture of the pre-trained language model, e.g., to better suit a specific task, use case, or domain. For example, such fine-tuning of the architecture may comprise one or more of adding task-specific layers, adjusting hyperparameters, and freezing certain layers to prevent them from being updated during fine-tuning.

Optionally or additionally, after fine-tuning the pre-trained language model at block 1200, the method 1000 may further comprise, at block 1600, validating and/or evaluating the fine-tuned model on a validation dataset and/or an evaluation dataset, respectively. This may include supervised validation steps. An evaluation can include benchmarking based on a test dataset. For instance, multiple finetuned language models (e.g., using statistical variations or certain variations in the training data) can be benchmarked and the benchmarks can be compared against each other.

According to various examples, after fine-tuning the pre-trained language model, the method 1000 may perform the step at 1300 again, if at least one further change associated with any one of the ontology, the vocabulary, and the at least one configured federated service is determined, the method 1000 may perform blocks 1100 and 1200 again.

If no further change associated with any one of the ontology, the vocabulary, and the at least one configured federated service is determined, the method 1000 may perform block 1400, i.e., deploying the fine-tuned language model.

Upon deploying the finetuned language model at block 1400, a prompt describing the desired data associated with the product can be obtained. For instance, a clear-language prompt specifying generation of a manual of a certain component or a certain set of components of a product may be obtained. The prompt may specify a certain malfunctioning of the product and may seek help to mitigate that malfunctioning of the product. Then, based on the prompt, a federated query associated with the desired data using the pre-trained language model that has been fine-tuned based on the techniques disclosed above can be generated. Based on this federated query, the desired data can be retrieved from the multiple data silos that are associated with the product, e.g., associated with different components of the product.

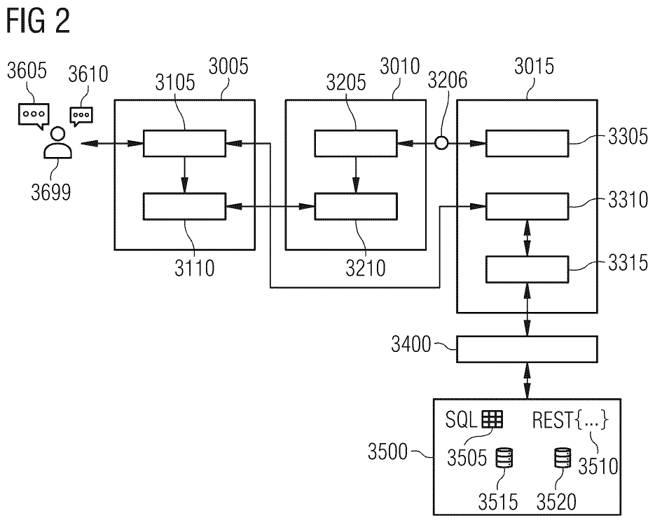

FIG. 2 schematically illustrates aspects relating to a data processing pipeline according to various examples. The data processing pipeline includes a plurality of modules 3005, 3010, 3015, 3400, 3510 that are coupled together. Module 3005 is a natural language interface module that provides a graphical user interface 3105 to a user 3699. The user 3699 may enter a natural language prompt 3605 via the graphical user interface 3105 (e.g., via typing or voice transcription) and receive a corresponding response 3610 (e.g., a text response). An inference application programming interface (API) 3110 is provided within the natural language application module 3005. The inference API 3110 can access the deployed language model 3210, which has been fine-tuned in a fine-tuning process 3205 of the fine-tuning software module 3010. Details regarding the fine-tuning process have been discussed previously in connection with the method 1000 of FIG. 1, specifically block 1500. In particular, the fine-tuning process 3205 accesses an ontology 3305 as metadata for the training, e.g., triggered based on monitoring 3206 for changes in the ontology 3305 (cf. FIG. 1: block 1300). The ontology 3305 is provided within an ontology module 3015, for example, as a graph data structure. The fine-tuning process 3205 then deploys the updated version of the language model 3210. The ontology module 3015 also includes a SPARQL engine 3310 that communicates with the graphical user interface 3105 of the natural language module 3005. The SPARQL engine 3310 accesses a particular federated service or multiple federated services of a federated service submodule 3315. The queries provided to a data layer module 3500 via an optional access layer module 3400 are typically service-specific. For example, the query for automatic generation of a manual may be substantially different from a query for maintenance/maintenance guidance. They can be determined in a service-specific manner by the language model 3210. The data layer module 3500 includes an SQL database 3505 and a Rest API 3510, as well as multiple data silos 3515, 3520. Based on such a query, data is returned that is used to determine the answer or response 3610; which is then output to the user.

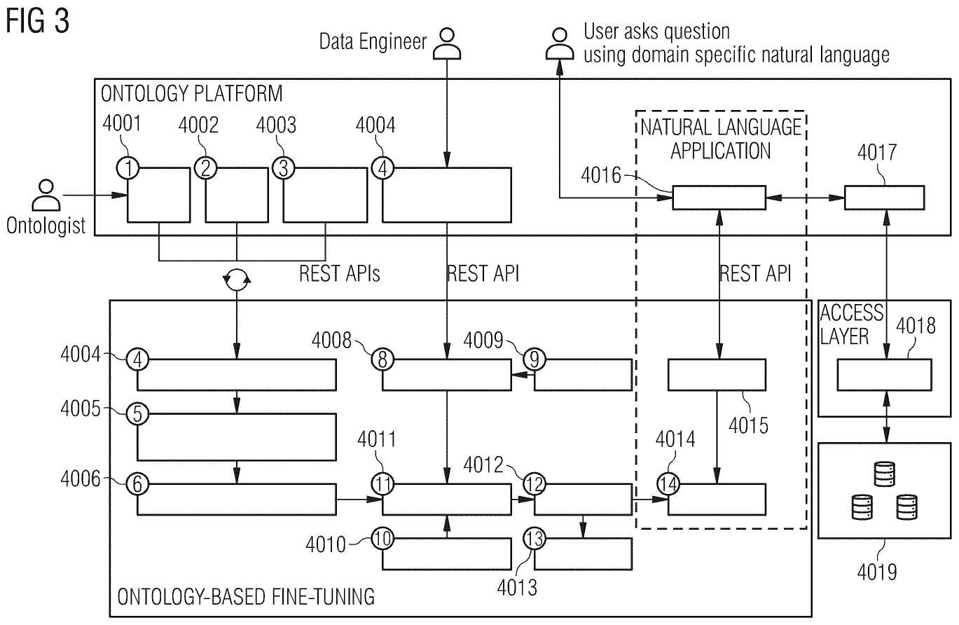

FIG. 3 schematically illustrates a workflow according to various examples. The workflow is associated aspects related to fine-tuning a pre-trained language model for generating a federated query associated with a product, and aspects related to generating, based on a prompt, a federated query associated with desired data using the pre-trained language model that has been fine-tuned. The workflow may be performed by the plurality of modules of FIG. 2.

The workflow comprises a fine-tuning process for periodically fine-tuning a pre-trained language model, e.g., a Sequence-to-Sequence Language Model, by feeding the pre-trained language model with first semantic metadata associated with an ontology (box 4001) representing concepts of a product and second semantic metadata associated with a vocabulary (i.e., box 4002) describing the concepts of the product. The ontology may comprise enterprise ontologies in Shapes Constraint Language (SHACL), which is W3C standard language for describing Resource RDF graphs. The vocabulary may comprise domain-specific vocabularies respectively represented using Simple Knowledge Organization System (SKOS). By using semantic metadata associated with enterprise ontologies and semantic metadata associated with domain-specific vocabularies, generation of federated queries, e.g., SPARQL queries, can be tailored to the enterprise context. In further detail, at box 4001, one or more ontologies associated with one or products are maintained by an expert user. At box 4002, one or more vocabularies associated with the respective product are maintained. At box 4003, optionally descriptions of configured federated services for accessing multiple data silos are maintained. The data structures maintained at box 4001, 4002, and 4003 can be used as semantic metadata for the training of the large language model. Accordingly, at box 4004, a fine-tuning process for fine-tuning the language model can detect any changes in the data maintained at box 4001, box 4002, and/or box 4003. For instance, it may be detected whether a new data structure becomes available or whether a pre-existing data structure is updated. At box 4005, the respective metadata that is retrieved upon detecting a respective change can be encoded in a vector embedding. This yields an unlabeled data set at box 4006 which can be used as an input, at box 4011, of a fine-tuning process for fine-tuning the language model. More generally, language model is trained on unsupervised datasets primarily through a process called unsupervised learning, where the language model learns to predict parts of the input data from other parts of the same data (here the vector embeddings from box 4005), without explicit external labels or annotations. In the context of text, this often involves predicting the next word given the previous words in a sentence. The unlabeled data set obtained at box 4006 can be complemented optionally by an annotated data set that is obtained at box 4008, e.g., from corresponding pairs of prompts and SPARQL queries defined—e.g., manually, by a data engineer—at box 4007. The language model is obtained at box 4010. For instance, the language model may be an open-source language model. Upon fine-tuning the language model, at box 4012, the fine-tuned language model may be stored and evaluated and/or validated, e.g., by a data engineer at box 4013. In case of a positive validation and/or evaluation result, the model is deployed at box 4014. Then, the inference API that has been previously discussed in connection with FIG. 2: inference API 3110, can access the deployed language model at box 4015 so that, at box 4016, a prompt obtained via a natural language application graphical user interface—as previously discussed in connection with graphical user interface 3105 in FIG. 2—can be fed to the fine-tuned language model. The SPARQL query thus obtained is provided to the SPARQL engine at box 4017 and via the access layer—box 4018—to the data layer—box 4019.

FIG. 3 thus illustrates a method that periodically fine-tunes a sequence-to-sequence language model by feeding it with domain-specific context derived from predefined ontologies (box 4001) and vocabularies (box 4002). This enhancement facilitates the generation of SPARQL queries tailored to the enterprise context. In addition, the context from available federated services (box 4003) mapped to company-owned data silos is incorporated into the fine-tuning process to generate increasingly precise SPARQL Federated Query. Box 4003 enables periodic fetching of enhanced semantic metadata from boxes 4001, 4002, 4003 and triggering the fine-tuning process of the language model automatically. The methodology also encompasses the generation of context-sensitive vector embeddings (box 4005) from semantic metadata of boxes 4001, 4002, 4003 for enhanced understanding of domain-specific context for the language model. These vector embeddings are generated using graph walking strategies and word-embeddings 5 for accurate representation of semantic information. A further instruction-based (box 4007) supervised fine-tuning (box 4008, box 4009) is performed on an open-source Sequence-to-Sequence Language Model (box 4010) using a precise natural language question and the corresponding SPARQL federated query. As a result, a high-performance task-specific language model (box 4012) can be produced for query generation. The efficacy of the fine-tuned language model in translating natural language question to corresponding SPARQL federated query is evaluated using, e.g., the Bilingual Evaluation Understudy (BLEU) metric (box 4013) using a validation dataset. The best performing model is then deployed (box 4014) in the ontology-based fine-tuning software system using an inference API.

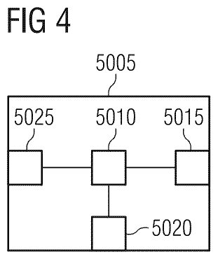

FIG. 4 schematically illustrates a processing device 5005 according to various examples. The processing device 5005 is configured to implement techniques disclosed herein in connection with a federated query. For example, the processing device 5005 can be configured to generate such a federated query by inferencing a language model and/or by refining the language model. The processing device 5005 can implement one or more of the blocks of the method 1000 of FIG. 1, and/or can implement one or more parts of the data processing pipeline of FIG. 2, and/or can implement one or more parts of the workflow of FIG. 3.

The processing device 5005 includes a processor 5010, e.g. a central processing unit and/or one or more graphics processing units and/or traction processing units. The processing device 5005 also includes a memory 5015 that stores program code. The program code can be loaded by the processor 5010 and executed by the processor 5010. Further, the processing device 5005 includes a communication interface 5020 through which data can be received from and/or transmitted to other computing devices. For example, a cloud server database or data repository can be accessed to obtain metadata, such as semantic metadata used to train a language model. Further, the processing device 5005 includes a human-machine interface 5025. The human machine interface 5025 can interact with the user, e.g., by providing a graphical user interface through which text input can be obtained, through which text output can be provided to the user, as previously explained in connection with FIG. 2 and a graphical user interface 3105. The processor 5010, upon loading and executing program code stored in the memory 5015, performs techniques as disclosed herein, e.g.: pre-training a language model; fine-tuning a pre-trained language model; inferring a language model; obtaining metadata, e.g., a graph data structure representing an ontology and/or text data representing a vocabulary; outputting and/or providing a fine-tuned language model after fine-tuning; and etc. . . . .

Summarizing, techniques have been disclosed that enable automating the generation of SPARQL Federated Query based on organization-specific user questions in natural language. The context sensitive vector embeddings from semantic data coupled with instruction based supervised fine-tuning using labelled SPARQL federated queries for large language models. This enables generation of domain specific SPARQL federated query from natural language for efficient information retrieval from multiple organizational data silos.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.
[1] Rony, Md Rashad Al Hasan, et al. “Sgpt: A generative approach for SPARQL query generation from natural language questions.” IEEE Access 10 (2022): 70712-70723.
[2] Luz F F, Finger M. Semantic parsing natural language into SPARQL: improving target language representation with neural attention. arXiv preprint arXiv: 1803.04329. 2018 Mar. 12.
[3] Wang R, Zhang Z, Rossetto L, Ruosch F, Bernstein A. Nlqxform: A language model-based question to sparql transformer. arXiv preprint arXiv: 2311.07588. 2023 Nov. 8.
[4] Panchbhai A, Soru T, Marx E. Exploring Sequence-to-Sequence Models for SPARQL Pattern Composition. arXiv preprint arXiv: 2010.10900. 2020 Oct. 21.
[5] Nikolov, Andriy, et al. “Ephedra: Efficiently combining RDF data and services using SPARQL federation.” Knowledge Engineering and Semantic Web: 8th International Conference, KESW 2017, Szczecin, Poland, Nov. 8-10, 2017, Proceedings 8. Springer International Publishing, 2017.
[6] Heling L, Acosta M. Federated SPARQL query processing over heterogeneous linked data fragments. InProceedings of the ACM Web Conference 2022 2022 Apr. 25 (pp. 1047-1057).
[7] Sima, Ana Claudia, et al. “Enabling semantic queries across federated bioinformatics databases.” Database 2019 (2019): baz106.
[8] Sander M, Waltinger U, Roshchin M, Runkler T. Ontology-based translation of natural language queries to SPARQL. In2014 AAAI fall symposium series 2014 Sep. 24.
[9] Javaheripi, Mojan, et al. “Phi-2: The surprising power of small language models.” Microsoft Research Blog (2023).
[10] Rakhmawati N A, Umbrich J, Karnstedt M, Hasnain A, Hausenblas M. Querying over Federated SPARQL Endpoints - - - A State of the Art Survey. arXiv preprint arXiv: 1306.1723. 2013 Jun. 7.
[11] Mitra A, Del Corro L, Mahajan S, Codas A, Simoes C, Agarwal S, Chen X, Razdaibiedina A, Jones E, Aggarwal K, Palangi H. Orca 2: Teaching small language models how to reason. arXiv preprint arXiv: 2311.11045. 2023 Nov. 18.
   Independent of the grammatical term usage, individuals with male, female or other gender identities are included within the term.

What is claimed is:

1. A computer-implemented method for fine-tuning a pre-trained language model for generating a federated query associated with a product from a prompt, the computer-implemented method comprising:
obtaining first semantic metadata and second semantic metadata, the first semantic metadata associated with an ontology representing concepts of the product, and the second semantic metadata associated with a vocabulary describing the concepts of the product; and
fine-tuning the pre-trained language model based on the first semantic metadata and the second semantic metadata.

2. The computer-implemented method of claim 1, further comprising:
obtaining third semantic metadata associated with at least one configured federated service, wherein each of the at least one configured federated service is mapped to a data silo storing data associated with the product; wherein
said fine-tuning of the pre-trained language model is further based on the third semantic metadata.

3. The computer-implemented method of claim 1, wherein said fine-tuning of the pre-trained language model is based on one or more vector embeddings of the first semantic metadata and the second semantic metadata.

4. The computer-implemented method of claim 1, further comprising:
determining at least one change associated with at least one of the ontology, the vocabulary, or a configured federated service; wherein
said fine-tuning of the pre-trained language model is triggered based on said determining of the at least one change.

5. The computer-implemented method of claim 1, wherein said fine-tuning of the pre-trained language model is triggered based on a defined timing schedule.

6. The computer-implemented method of claim 1, further comprising:
obtaining one or more prompts and one or more corresponding ground-truth federated queries; wherein
said fine-tuning of the pre-trained language model is further based on the one or more prompts and the one or more corresponding ground-truth federated queries.

7. The computer-implemented method of claim 1, wherein the product includes a projection radiographic scanner, a magnetic resonance imaging scanner, a computed tomography scanner, a positron emission tomography scanner, a single-photon emission computed tomography scanner, or an ultrasound scanner.

8. The computer-implemented method of claim 1, wherein the federated query includes a protocol and resource description framework query language query.

9. The computer-implemented method of claim 1, wherein the federated query is for accessing multiple data silos associated with different components of the product.

10. The computer-implemented method of claim 1, wherein upon completing said fine-tuning, the computer-implemented method further comprises:
at least one of validating or evaluating the pre-trained language model.

11. A computer-implemented method, comprising:
obtaining a prompt describing desired data associated with a product; and
generating, based on the prompt, a federated query associated with the desired data using a pre-trained language model fine-tuned by the computer-implemented method of claim 1.

12. The computer-implemented method of claim 11, further comprising:
retrieving, from multiple data silos storing data associated with the product, the desired data based on the federated query generated based on the prompt.

13. A processing device comprising:
a processor and a memory, the processor configured to cause the processing device to
obtain first semantic metadata and second semantic metadata, the first semantic metadata associated with an ontology representing concepts of a product, and the second semantic metadata associated with a vocabulary describing the concepts of the product, and
fine-tune, based on the first semantic metadata and the second semantic metadata, a pre-trained language model for generating a federated query associated with the product from a prompt.

14. A processing device comprising:
a processor configured to cause the processing device to perform the computer-implemented method of claim 1.

15. A non-transitory computer-readable storage medium storing program code that, when executed by at least one processor, causes the at least one processor to perform the computer-implemented method of claim 1.

16. The computer-implemented method of claim 2, wherein said fine-tuning of the pre-trained language model is based on one or more vector embeddings of the first semantic metadata and the second semantic metadata.

17. The computer-implemented method of claim 2, further comprising:
determining at least one change associated with at least one of the ontology, the vocabulary, or a configured federated service; wherein
said fine-tuning of the pre-trained language model is triggered based on said determining of the at least one change.

18. The computer-implemented method of claim 17, further comprising:
obtaining one or more prompts and one or more corresponding ground-truth federated queries; wherein
said fine-tuning of the pre-trained language model is further based on the one or more prompts and the one or more corresponding ground-truth federated queries.

19. The computer-implemented method of claim 2, further comprising:
obtaining one or more prompts and one or more corresponding ground-truth federated queries; wherein
said fine-tuning of the pre-trained language model is further based on the one or more prompts and the one or more corresponding ground-truth federated queries.

20. The computer-implemented method of claim 2, wherein said fine-tuning of the pre-trained language model is triggered based on a defined timing schedule.
